(19) United States
(12) Patent Application Publication
(10) Pub. No.: US 2007/0268268 A1
(43) Pub. Date: Nov. 22, 2007

(54) Touchpad Device

(76) Inventor: Anthony Allison, Berkshire (GB)

Correspondence Address: Weiner & Burt, 635 N. US -23, P. O. Box 186, Harrisville, MI, 48740, US

(21) Appl. No.: 11/659,436

(22) PCT Filed: Aug. 2, 2005
(86) PCT No.: PCT/GB05/03016

§ 371 Date: May 2, 2007

(30) Foreign Application Priority Data
Aug. 3, 2004 (GB) 0417293.8

(51) Int. Cl. G06F 3/033

(52) U.S. Cl. 345/173

(57) ABSTRACT

A touchpad device for use with electronic apparatus is disclosed. The device has an active area that is sensitive to movement thereon and to generate electrical signals in response thereto for inputting into the electronic apparatus. The active area of the device defines a plurality of active portions, each of which is arranged to produce an electrical signal in response to at least one defined movement thereon. The device is provided with mounting means comprising a deformable portion for mounting on a substrate of variable size. It is envisaged that the substrate would be one or more fingers of a user, whereby the active portions may be activated by movement thereover of the user's thumb.

The present invention relates to an input device and in particular, but not exclusively, to a touchpad device.

Known touchpad devices are used in conjunction with computers, workstations, and electronic displays (such as computer-based projection equipment) and typically enter data via a keyboard or a pointing device. Pointing devices can be used for positioning a cursor and entering commands to a device, for example a computer, and include such devices as a personal computer mouse, trackball, pen stylus, and the like.

Touchpad devices for apparatus such as televisions, console gaming devices, electronic displays and presentation equipment, Internet access devices, DVD players and video recorders typically enter information, or control the function of the apparatus, by use of a touchpad device which is remote from the apparatus and incorporates buttons, switches and/or controls.

US2003/0214481 discloses a mobile finger worn and finger operated input device for a personal computer, workstation or the like. The input device comprises a sensor which is worn securely on the thumb. The input device includes a sensing area coincident with the tip of the thumb to sense relative movement in two orthogonal directions. One problem with this device is the limited size of the active area. This document addresses this problem by teaching use of an index finger stall with a small stylus so as to provide a higher resolution than when compared with using a finger tip.

It is an object of the present invention to provide an improved touchpad device.

According to a first aspect of the present invention there is provided a touchpad device, for use with electronic equipment, the device having an active area sensitive to movement thereon, and being arranged to generate electrical signals, in response to said movement, for inputting into electronic apparatus, the active area of the input device defining a plurality of active portions, each active portion being arranged to produce an electrical signal in response to at least one defined movement thereon, wherein the device is provided with mounting means for secure mounting onto a substrate of variable size.

The mounting means may be provided with a deformable portion so as to allow attachment of the device to the substrate. The deformable portion may be a resiliently deformable portion. Preferably, the device is arranged for mounting on a substrate that comprises one or more fingers of a user.

A touchpad device which can be mounted on more than one finger provides the advantage that it is capable of having a larger active surface area than a device that can be mounted only on a single digit of a user.

According to another aspect of the present invention there is provided a touchpad device having an active area sensitive to movement thereon, the device being arranged to generate electrical signals, in response to said movement, for inputting into electronic apparatus, the active area of the input device defining a plurality of active portions, each active portion arranged to produce an electrical signal in response to at least one defined movement thereon, wherein at least one of the active portions overlaps another active portion and wherein the device is provided with selection means for selecting which of the relevant electrical signals associated with the overlapping active portions is to be outputted in response to movement within the overlapping region of the active portions.

The selection means may be provided in software associated with the input device. Preferably the touchpad device is arranged to be worn on a finger and operated by a thumb of a user.

The term “movement” means herein any movement across the active area with or without pressure applied to the surface thereof, a change of pressure applied to the surface of the active area with or without movement across the active area, or a combination thereof. The active area of the device may be arranged to have a number of pressure thresholds such that a different electrical signal is generated when a user applies a different pressure to the surface of the active area. Therefore, the active area can detect a movement in any one or more of three dimensions.

The movement made by the user on the active area is commonly referred to hereinafter as a gesture.

Providing a device having overlapping active portions provides the advantages of being able to increase the number of active portions on a limited surface area of an input device, allows the size of the active portions to be increased, or a combination thereof.

Preferably, a defined movement on a particular active portion generates a specific electrical signal to control a function of the electronic apparatus. That is to say, a specific gesture made by a user can control a function of the electronic apparatus when that gesture is made in one of the active portions and may control the same, or a different function, when the same gesture is made in a different active portion.

The electrical signal generated from movement in an overlapping region may be determined from that movement initiated in a non-overlapping region of one of the overlapping active portions, even though the movement continues into the overlapping region.

The active portion may generate one of a plurality of electrical signals relating to a particular defined movement performed in the active portion.

Preferably, the movement initiated in an overlapping region that corresponds to a movement associated with only one of the overlapping active areas generates the output signal associated with that movement. This may occur when a unique gesture is associated with one of the active portions and the user initiates or performs that unique gesture in an overlapping region.

The movement initiated in an overlapping region of active portions may generate a null output until the movement is continued into a non-overlapping active portion. This may occur when a movement made by the user, which is initiated in an overlapping region, could relate to one of a number of possible signals related to the two regions and it is only evident what the intended signal is when the movement enters into a non-overlapping region.

According to a further aspect of the present invention there is provided a touchpad device, for use with electronic equipment, the device having an active area sensitive to movement thereon, and being arranged to generate electrical signals, in response to said movement, for inputting into electronic apparatus, the active area of the input device defining a plurality of active portions, each active portion arranged to produce an electrical signal in response to at least one defined movement thereon, wherein active portions are provided with different textured surfaces for providing tactile differentiation therebetween.

The feature of different textured surfaces, to facilitate tactile differentiation between the active portions of the device, provides the advantage of allowing identification of the different active portions by, for example, passing a finger of a hand of the user over the surface of the active area and therefore reduces the need to look at the input device to determine positioning of the finger of the user on the active area of the touchpad

The touchpad device may include mounting means for secure mounting onto a substrate of variable size.

The term “substrate” means herein any base onto which the device can be mounted, and includes for example, a body part of a user, such as a finger, thumb or palm of a hand.

Advantageously, the active area of the device is sensitive to contact pressure applied thereto and the movement may comprise a change in contact pressure that generates an output signal corresponding to a function of the electronic apparatus.

The touchpad device may be arranged such that the greater the pressure applied to the surface of the active area the faster an operation takes place, for example, the faster a pointer moves across a screen. Alternatively, the device may be arranged such that the greater the force of pressure applied to the surface of the active area the slower an operation is performed.

Preferably, the active area comprises a plurality of discrete active portions thereon. The discrete portions may be raised, physically moveable buttons. Alternatively, the discrete portions may be button areas defined on a flat surface, defined on the surface of the active area but are typically defined by software associated with the touchpad device.

In one embodiment, the active portions are arranged to correspond to, and function as, controls of a mouse for a personal computer. In an alternative embodiment the active portions are arranged to correspond to, and function as, buttons of a keypad of a telephone or a game controller.

Providing a touchpad device having buttons corresponding to and functioning in a similar role as a mobile telephone, i.e. in a text entry mode, enables a user to use the touchpad device as an alphanumeric input device. Such an embodiment enables the touchpad device to input text data to an electronic apparatus in a manner similar to that of a keypad of a mobile phone.

Preferably, the device includes a port for wireless communication of data between the device and the electronic apparatus.

The device may be powered by an internal battery, which may be rechargeable by proximal induction.

The device may further include aural feedback to indicate the position of an operating member over or on an active portion and activation of an active portion. The aural feedback may comprise two contrasting sounds that indicate respectively selection of an active portion and activation of said active portion.

It is to be understood that various features of the different aspects of the invention may be selectively combined together in any one embodiment of the touchpad device.

Embodiments of the present invention will now be described with reference to the accompanying drawings in which:

FIG. 1 is a schematic illustration of a touchpad device having overlapping active portions;

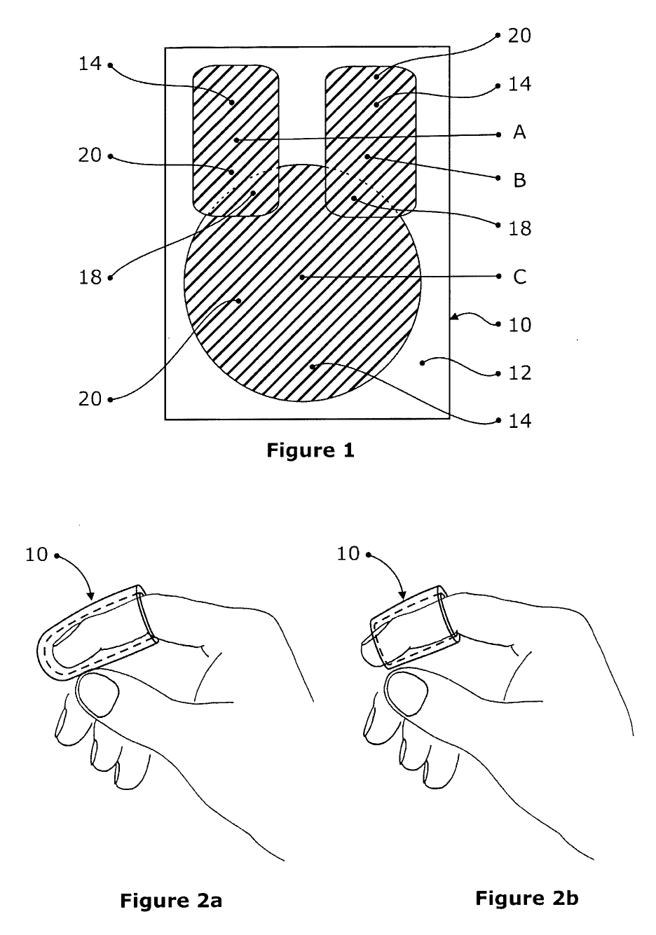

FIGS. 2a and 2b are schematic illustrations of embodiments of a touchpad device mounted on a finger of a user;

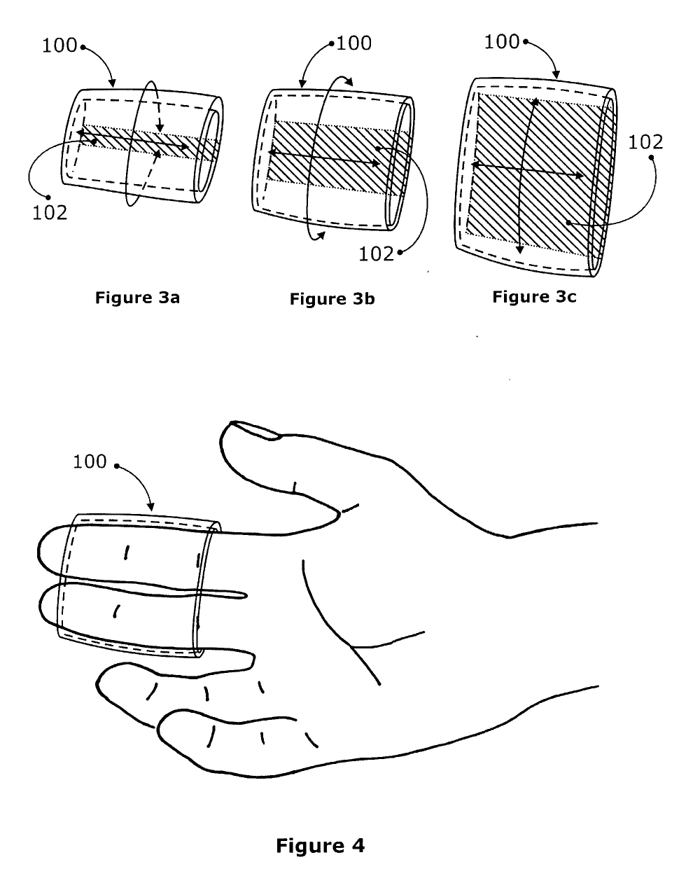

FIGS. 3a to 3c are schematic illustrations of a touchpad device having a resiliently deformable portion;

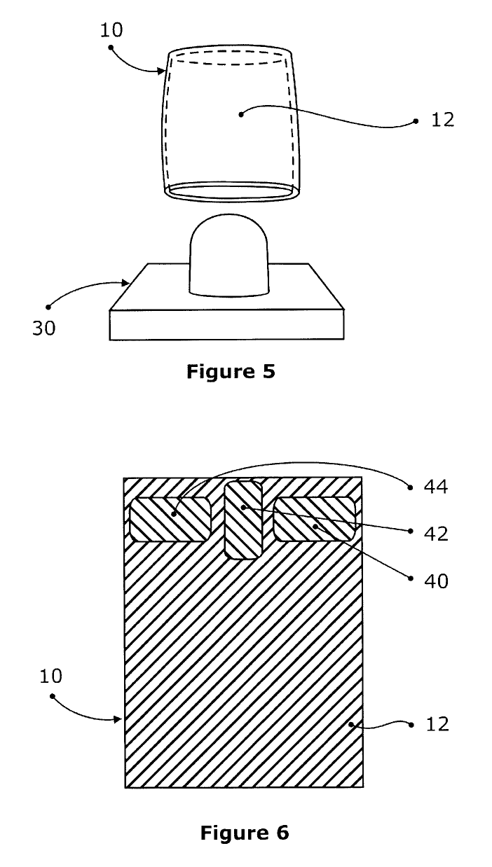

FIG. 4 is a schematic illustration of the touchpad device of FIG. 3 mounted on two fingers of a user;

FIG. 5 is a schematic illustration of the touchpad device and a base unit for wireless communication with the touchpad device;

FIG. 6 is a schematic illustration of one embodiment of an active area of the touchpad device corresponding to the buttons of a mouse for a personal computer;

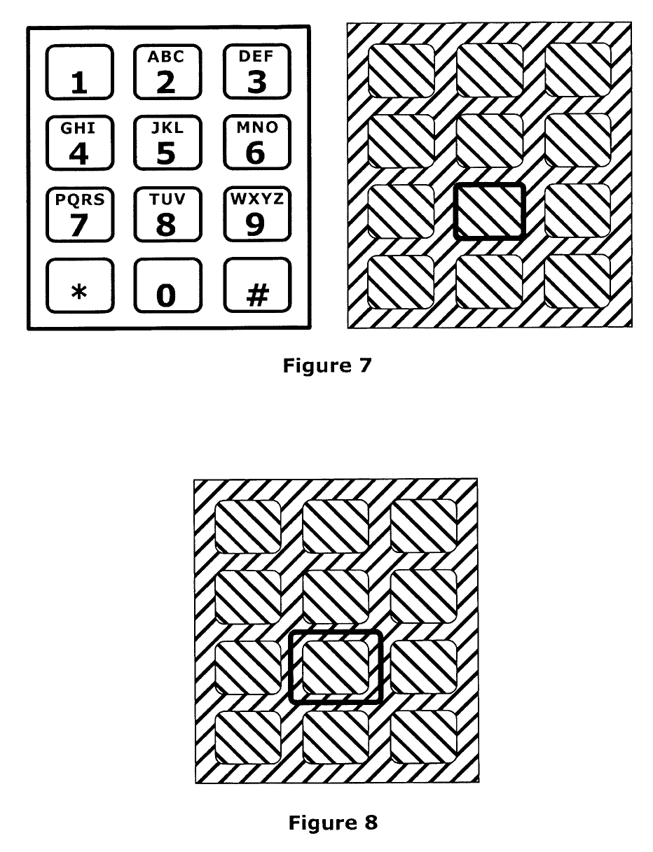

FIG. 7 is a schematic illustration of an alternative embodiment of the active area of the touchpad device corresponding to the keys of a telephone pad;

FIG. 8 is a schematic illustration of a “magnetic area” of an active portion of the active surface; and

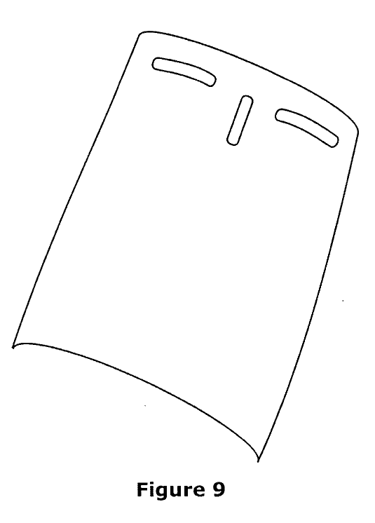

FIG. 9 is a schematic illustration of a mask having buttons corresponding to the active button on the device.

Referring to FIG. 1, a touchpad device 10 has an active area 12 sensitive to movement across the surface of the active area 12 and/or sensitive to a pressure applied to the surface of the active area 12. The device 10 is designed and arranged to generate an electric signal, which is transmitted to an electronic apparatus (not shown) in response to the movement, so as to control or input data to the apparatus. The active area of the device has, defined on the surface thereof, a number of active portions 14 arranged to produce a signal to control a function of the apparatus. The active portions may be raised, moveable buttons or areas physically defined on a flat surface. Preferably, however, the active portions are virtual areas, defined by software associated with the touchpad. The active portions 14 are arranged such that one active portion 14 overlaps another active portion 14 and thereby define overlapping portions 18 and non-overlapping portions 20.

FIG. 1 indicates one configuration of the active portions 14 provided on the active area 12 of the device 10. In this exemplary embodiment the active portions 14 correspond to functions of a game console for a driving game. The car in the game is controlled as follows:

Pressing the area A accelerates the car; the more pressure that is applied, the greater the acceleration.

Pressing the area B applies the car's brakes; the more pressure that is applied, the greater the deceleration

Stroking the area A in one direction changes the car's gear up; stroking the area B in the opposite direction changes the car's gear down

Making a clockwise rotating gesture in the area C turns the car steering in one direction; making a counter clockwise rotating gesture in the area C turns the car steering in the opposite direction.

Although the buttons overlap, the control software will take into account both the location of finger contact and the gesture being made—movement or still—and will interpret the input as though the buttons were entirely distinct.

It will be understood that an all-but infinite range of button shapes and control gestures can be implemented in the device and that the buttons are overlapped in order to provide as much functionality as possible in a small area.

Referring also to FIGS. 2a and 2b, the active area 12 can cover all or part of the touchpad device 10. The active area of the device can be made in the shape of any three-dimensional form between completely flat and highly curved, and which form can be up to and beyond the curve of a human finger. This may be achieved using various technologies such as Cirque Corporation's GlideSensor touchpad module or similar module. The touchpad device is designed to be conformable so as to adapt to the size and shape of a finger of a user.

The device 10 is affixed to the finger by an elastic sleeve or membrane on or in which the device is mounted as illustrated in FIGS. 2a and 2b. FIG. 2a shows an embodiment of the device which is similar to a thimble, in that the device covers the entire tip of the finger at a distal end, or free end, of the finger and the device extends towards the palm of the hand. In an alternative embodiment the portion of the device that covers the finger tip is not present allowing the finger tip of the user to be exposed when the device is fitted to the finger, as illustrated in FIG. 2b.

Referring now to FIGS. 3a to 3c, there is a touchpad device 100 in accordance with another aspect of the present invention. The touchpad device 100 includes a flexible, elastic section 102, which enables the device 100 to be fitted to one or more fingers of the user, as illustrated in FIG. 4. This embodiment provides the advantage of having a greater surface area available to be used as the active area of the touchpad device. The touchpad device can of course be adapted to fit three or four fingers, and can be open or closed at the distal end of the device as illustrated in FIGS. 2a and 2b. Furthermore, this embodiment of the invention will allow the device to be mounted to any suitable substrate.

Referring now to FIG. 5, the device 10, includes a power source and electronic circuitry, (not shown) to detect both movement across and movement into (i.e. pressure) the active area 12 by a finger. The electronic circuitry determines the direction of movement and pressure of the user's finger on the active area and converts the movement into data, which is transmitted as a signal and used by the apparatus. This data is transmitted to a base unit 30 by a wireless or fixed connection. The data received by the base unit 30 uses software to interpret and manage the data so as to facilitate control over the apparatus. The software may be incorporated in the apparatus, eg pc or games machine, being operated or controlled.

The device may communicate wirelessly with the base unit by radio frequency, infrared or other similar means of transmission and reception. The method of communication may include the use of open radio frequencies and/or closed frequencies such as those reserved for Bluetooth systems.

The base unit may be incorporated in the apparatus to be controlled and an aerial may be associated with the apparatus to assist in extending reception capability.

One method of charging the touchpad device 10, 100 is by way of non-contact induction, whereby a battery or a cell in the device is recharged by a process of proximal induction from a current flowing in a charging section of the base unit.

Referring now to FIG. 6, the active area 12 of the device is segmented into various different active buttons 40,42,44 which are used to relay different information to the apparatus. In this embodiment the active buttons 40,42,44 correspond to the standard controls of a personal computer (PC) mouse. Button 40 corresponds to the right mouse button, button 42 corresponds to the scroll button, which may be operated by stroking a finger up or down that part of the active area 12, for example, scroll up or down a viewed page, and button 44 corresponds to the left mouse button. It will be appreciated that the active buttons 40, 42, 44 can be arranged to overlap one another as depicted in the embodiment of FIG. 1.

Referring now to FIG. 7, there is shown an alternative embodiment of a layout of the active buttons. In this embodiment the active buttons are arranged like a telephone-style keyboard. This type of active area can be used for inputting text, commands and data, and is highlighted for one of the buttons.

In this embodiment the touchpad device can be used for entering text, in common with the well-known method of text pad key entry as used in mobile phones, multiple selections of the same key will correspond in turn to letters indicated on the buttons. That is, when the device is set to input text, one click on the button labelled “2” will correspond to text entry “A”, two clicks will correspond to “B” and three clicks will correspond to “C”. The input method may use the well-known concept of predictive text to facilitate very rapid text and data input. The input method may also incorporate what are commonly known as ‘short cuts’ for use in specific applications such as game play and Internet web browsing, whereby the user may make simple finger gestures to complete a more complex input, such as inputting the nomenclature of a web site locator (i.e. www) or to add common extensions such as .htm, .com or .co.uk with simple gestures.

This embodiment provides a method of data input based on the well known method of text input into mobile telephones and personal digital assistants, whereby the active area of the touchpad is provided with active portions in the form of a ‘keypad’ allowing the user to rapidly input text and data and to control special functions without the need to display a full computer or typewriter-style keyboard.

The active buttons may have actions that differ according to how that part of the active area is addressed by a finger. That is, different gestures applied to one button may produce different inputs.

In accordance with yet other embodiments of the present invention, the active buttons on the active area may have indentations, protuberances, or textures of all manner of shapes and sizes so as to help the operator identify the location, and thus function, of the buttons by touch alone.

Various modifications may be made to the invention without departing from the scope thereof. For example, the device may be mounted to the finger by means of a highly conformable plastic form similar to a finger from a rubber glove, in which the device is mounted, or a rigid outer casing with a foam style insert to accommodate the finger in comfort. The means for permitting stretching may be made from a flexible conformable or elastic material and have a gap such that the device may stretch around one, two, three or four fingers. The input device may be connected to the apparatus via a physical link such as a cable, or the device may use a method of detection whereby the base unit acts as both transmitter and receiver. The transmitter signal may be modified by the electronics in the finger mounted device. This modified signal may then be detected by the base unit and converted into appropriate data to control the operated system.

The touchpad device 10, 100 may further comprise one or more removable masks or overlays, as illustrated in FIG. 9, that have pre-moulded buttons that correspond to the active buttons on the active area of the device. The overlays are adapted so as to not impede the device from detecting contact, movement or pressure of a finger applied to the active area. The overlay may incorporate buttons corresponding to control features required to operate a program for a PC or console game or the like. In this case, the program could be notified that an overlay has been applied by automatic detection means, manual notification through control software or the like, and handle the data from the touchpad device accordingly. The removable mask can be removed at any time and the active area set or reset to whatever input style the operator desires.

In one embodiment an image of the buttons is displayed on the apparatus, for example a computer, mobile telephone, TV or the like, which correspond to the active buttons on the input device.

In another embodiment, the method of selecting an active button may include a “magnetic selection” or “snap function” operation. This method of operation assists selection of a button by automatically moving a selection pointer or other selection tool to the nearest button as the pointer enters its “magnetic” area, indicated by the rectangular boxes around each of the buttons, only one of which is illustrated in FIG. 8. Thus the user need make only fairly coarse movements in order to select precisely the button or function required.

In use, magnetic selection, especially in conjunction with an on-screen display, functions such that an on-screen pointer will snap to the closest on-screen or key function as the user makes gestures on the active area to move the pointer towards that key or function. Therefore, it appears that the keys or functions are magnetic and that the pointer is attracted to those keys or functions in such a way as to make it easier to highlight or select those keys or functions with coarser finger movements.

In one embodiment the method of operating the device includes the step of being able to dynamically adjust the active area of the device allowing the user to define the active area to be the most comfortable area according to the articulation of the user and according to the orientation or position of use of the input device. The method can also include the step of adjusting the orientation of the active area on the device such that movement of a finger along the surface of the active area corresponding to a “straight line” movement, i.e. vertical, horizontal or diagonal, on the screen, can be adjusted.

In a further embodiment the active area uses aural feedback which comprises two contrasting voices to indicate that the finger is respectively positioned to select and activate a button, i.e. when the finger moves over a button X a female voice says X and when the button is pressed a male voice says X.

In yet a further embodiment the region of the active area 12 not having active portions 14 defined thereon is a functional active region, which can be used, for example, for positioning a cursor.

In yet a further embodiment, any one or more of the position, shape and function of the active portions 14 of the device 10 can be allocated by the user. That is to say the layout of the active portions can be defined by the user in a very large number of possibilities.

1. A touchpad device, for use with electronic equipment, the device having an active area sensitive to movement thereon, and being arranged to generate electrical signals, in response to said movement, for inputting into electronic apparatus, the active area of the input device defining a plurality of active portions, the active area being arranged to produce an electrical signal in response to at least one defined movement that extends across one or more of the active portions and across their boundaries, wherein the device is provided with means for secure mounting onto a substrate of variable size.

2. A touchpad device, for use with electronic equipment, the device having an active area sensitive to movement thereon, and being arranged to generate electrical signals, in response to said movement, for inputting into electronic apparatus, the active area of the input device defining a plurality of discrete active portions, each active portion being arranged to produce a defined electrical signal in response to at least one defined movement thereon, the defined electrical signal being produced by a continuous movement over one of said active portions and across a boundary thereof on to another of said active portions, wherein the device is provided with mounting means for secure mounting onto a substrate of variable size.

3. A touchpad device according to claim 1, wherein a respective electrical signal is produced by at least two defined movements on each active portion thereof.

4. A device according to claim 1, wherein the mounting means is provided with a deformable portion so as to allow attachment of the device to the substrate.

5. A device according to claim 1, wherein the deformable portion is a resiliently deformable portion.

6. A device according to claim 1, wherein the mounting means is arranged for mounting the device onto a substrate that comprises one or more fingers of a user.

7. A device according to claim 1, wherein the active area is sensitive to contact pressure applied thereto and wherein the movement comprises a change in contact pressure that generates an output signal corresponding to a function of the electronic apparatus.

8. A device according to claim 1, wherein at least one of the active portions overlaps another active portion and wherein the device is provided with selection means for selecting which of the relevant electrical signals associated with the overlapping active portions is to be outputted in response to the defined movement within the overlapping region of the active portions.

9. A device according to claim 8, wherein a defined movement on a particular active portion generates a specific electrical signal to control a function of the electronic apparatus.

10. A device according to claim 8, wherein the electrical signal generated from movement in an overlapping region is determined from that movement initiated in a non-overlapping region of one of the overlapping active portions, which movement continues into the overlapping region.

11. A device according to claim 8, wherein the active portion generates one of a plurality of electrical signals respective to a particular defined movement performed in the active portion.

12. A device according to claim 8, wherein movement initiated in an overlapping region that corresponds to a movement associated with only one of the overlapping active areas generates the output signal associated with that movement.

13. A device according to claim 8, wherein movement initiated in an overlapping region of active portions generates a null output until the movement is continued into a non-overlapping active portion.

14. A device according to claim 1, wherein the device comprises one or more interchangeable masks that are mountable over the active area of the input device, the or each mask having different textured surfaces.

15. A device according to claim 14, wherein the or each mask is provided with readable means for identifying the mask, the readable means used to provide information so as to define the active portions on the device.

16. A device according to claim 14, wherein the active portions are arranged to correspond to, and function as, controls of a mouse for a personal computer.

17. A device according to claim 1, wherein the active portions are arranged to correspond to, and function as, buttons of a keypad of a telephone or a game controller.

18. A device according to claim 1, comprising means for aural feedback to indicate the position of an operating member over or on an active portion and activation of an active portion.

19. A device according to claim 1, wherein the active portions of the device have any one of a shape, position, size or orientation that can be defined by the user.

20. A touchpad device according to claim 1 in combination with electronic equipment that is arranged to display information in accordance with the generated electrical signals.

21-29. (canceled)
